(19) United States
(12) Patent Application Publication
(10) Pub. No.: US 2021/0036270 A1
(43) Pub. Date: Feb. 4, 2021

(54) Battery Pack and Battery Module

(71) Applicant: Marelli Corporation, Saitama-shi, Saitama (JP)

(72) Inventors: Toshiyuki Motohashi, Saitama-shi, Saitama (JP); Takayuki Hirase, Saitama-shi, Saitama (JP); Norio Suzuki, Saitama-shi, Saitama (JP)

(21) Appl. No.: 17/044,002

(22) PCT Filed: Mar. 28, 2019
(86) PCT No.: PCT/JP2019/013527

§ 371 Date: Sep. 30, 2020

(30) Foreign Application Priority Data
Apr. 10, 2018 (JP) 2018-075682
Apr. 10, 2018 (JP) 2018-075695

(51) Int. Cl. H01M 2/02; H01M 10/613; H01M 10/6555

(52) U.S. Cl. CPC H01M 2/024; H01M 2220/20; H01M 10/6555; H01M 10/613

(57) ABSTRACT

A battery pack includes battery cells stacked in a predetermined direction, cell cases housing the battery cells, a restraining plate attached to the cell cases, and a case housing the cell cases. The cell cases include openings at each side in the predetermined direction. The restraining plate exerts pressure on the battery cells through the openings from one end in the predetermined direction. The case includes a bottom surface. The bottom surface exerts pressure on the battery cells through the openings from the opposite side from the side where the restraining plate exerts pressure on the battery cells.

### CROSS-REFERENCE TO RELATED APPLICATIONS

The present application claims priority to and the benefit of Japanese Patent Application No. 2018-75682 filed Apr. 10, 2018, and Japanese Patent Application No. 2018-75695 filed Apr. 10, 2018, the entire contents of which are incorporated herein by reference.

### TECHNICAL FIELD

The present disclosure relates to a battery pack and a battery module.

### BACKGROUND

A chargeable/dischargeable battery module that includes a plurality of battery cells is known. For example, patent literature (PTL) 1 discloses a battery module in which a plurality of battery cells are arranged inside an upper frame and lower frame that are joined together. In this battery module, two battery cells at a time are housed in a cell cover to suppress swelling of the battery cells. Two battery cells are housed between cell cover portions in this battery module, and the cell cover portions are elastically coupled. The battery module is configured by stacking these cell covers.

### CITATION LIST

### Patent Literature

PTL 1: JP 5154454 B2

### SUMMARY

### Technical Problem

The above-described battery module has a complex configuration in which battery cells are housed in cell covers that are then stacked. Consequently, as the number of battery cells increases, the number of steps for housing the battery cells in cell covers increases proportionally.

In light of these considerations, it is an object of the present disclosure to suppress swelling of battery cells with a simple configuration.

### Solution to Problem

To resolve the aforementioned problem, a battery pack according to an embodiment of the present disclosure includes:

a plurality of battery cells stacked along a predetermined direction;

a cell case housing the battery cells;

a restraining plate attached to the cell case; and

a case housing the cell case;

wherein the cell case includes an opening at each side in the predetermined direction;

wherein the restraining plate exerts pressure on the battery cells via an adhesive layer or a first insulating layer through the opening from one side in the predetermined direction;

wherein the case includes a bottom surface; and

wherein the bottom surface of the case exerts pressure on the battery cells through the opening from an opposite side from the side where the restraining plate exerts pressure on the battery cells.

To resolve the aforementioned problem, a battery module according to an embodiment of the present disclosure includes:

a stacked plurality of battery cells;

a cell case surrounding the plurality of battery cells;

a housing supporting the cell case and the plurality of battery cells; and

a heat sink inserted between battery cells among the plurality of battery cells;

wherein the heat sink includes a fastening point projecting from the cell case and fastened to the housing; and

wherein the heat sink is fastened to the housing, and the heat sink and the housing sandwich the battery cells.

To resolve the aforementioned problem, a battery module according to an embodiment of the present disclosure includes:

a stacked plurality of battery cells;

a cell case supporting the plurality of battery cells inside the cell case; and

a heat sink sandwiched between battery cells among the plurality of battery cells;

wherein the heat sink projects from the cell case and is fixed to a housing configured to house the cell case; and

wherein a fixing point of the cell case is positioned in a central region of the cell case in a stacking direction of the battery cells.

### Advantageous Effect

A battery pack and battery module according to embodiments of the present disclosure can suppress swelling of battery cells with a simple configuration.

### BRIEF DESCRIPTION OF THE DRAWINGS

In the accompanying drawings:

FIG. 1 is an exploded perspective view illustrating a configuration example of a battery pack according to an embodiment;

FIG. 2 is an external perspective view illustrating a configuration example of a battery pack according to an embodiment;

FIG. 3A is a top view of a battery cell;

FIG. 3B is a side view of a battery cell;

FIG. 4 is an exploded perspective view illustrating a configuration example of a battery module;

FIG. 5A is a schematic diagram illustrating a representative first step for assembling a battery module;

FIG. 5B is a schematic diagram illustrating a representative second step for assembling a battery module;

FIG. 5C is a schematic diagram illustrating a representative third step for assembling a battery module;

FIG. 5D is a schematic diagram illustrating a representative fourth step for assembling a battery module;

FIG. 5E is a schematic diagram illustrating a representative fifth step for assembling a battery module;

FIG. 5F is a schematic diagram illustrating a representative sixth step for assembling a battery module;

FIG. 5G is a schematic diagram illustrating a representative seventh step for assembling a battery module;

FIG. 5H is a schematic diagram illustrating a representative eighth step for assembling a battery module;

FIG. 6 is an exploded perspective view illustrating a configuration example of an auxiliary module;

FIG. 7 is a perspective view illustrating an example of assembling a battery module and an auxiliary module;

FIG. 8 is an exploded perspective view illustrating a configuration example of an upper case;

FIG. 9 is a perspective view illustrating a configuration example of a battery module being housed in a lower case;

FIG. 10 is a cross-section along the A-A line in FIG. 9;

FIG. 11 is an enlargement of the portion surrounded by a dashed line in FIG. 10;

FIG. 12 is a cross-section along the B-B line in FIG. 2;

FIG. 13 is a cross-section illustrating a modification to FIG. 12;

FIG. 14A is a cross-section illustrating an example in which the protrusion of the lower case has an offset shape;

FIG. 14B is a cross-section illustrating an example in which the protrusion of the lower case has a camber shape;

FIG. 14C is a cross-section illustrating an example in which the protrusion of the lower case has a ribbed shape;

FIG. 15A is a cross-section illustrating an example in which the protrusion of a restraining plate has an offset shape;

FIG. 15B is a cross-section illustrating an example in which the protrusion of the restraining plate has a camber shape;

FIG. 15C is a cross-section illustrating an example in which the protrusion of the restraining plate has a ribbed shape; and

FIG. 16 is a top view illustrating another configuration example of a battery cell.

### DETAILED DESCRIPTION

An embodiment of the present disclosure is described below with reference to the drawings. The front-back, left-right, and up-down directions in the description below take the directions of the arrows in the figures as a reference. In an embodiment, the stacking direction of a plurality of battery cells 10 is the up-down direction, but this example is not limiting. The stacking direction of the plurality of battery cells 10 may be any other direction.

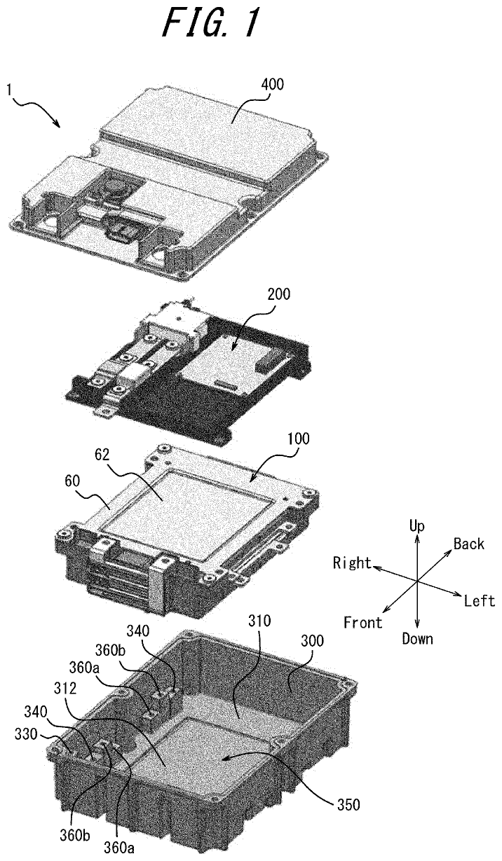

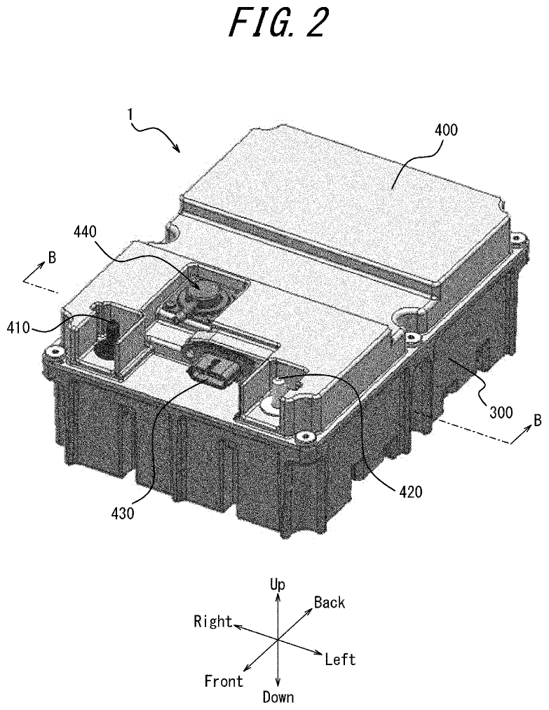

FIG. 1 is an exploded perspective view illustrating a configuration example of a battery pack 1 according to an embodiment. FIG. 2 is an external perspective view illustrating a configuration example of the battery pack 1 according to an embodiment.

In an embodiment, the battery pack 1 may be mounted and used in a vehicle, such as a vehicle that includes an internal combustion engine or a hybrid vehicle that can run on power of both an internal combustion engine and an electric motor. The battery pack 1 may, for example, be mounted under a seat of the vehicle. The battery pack 1 may, for example, be mounted inside the center console of the vehicle. The battery pack 1 is not limited to being used in a vehicle and is applicable to other uses.

As illustrated in FIG. 1, the battery pack 1 includes a battery module 100, an auxiliary module 200, a lower case 300, and an upper case 400. The lower case 300 and the upper case 400 are engaged by a fastening structure, such as screwing; by a fitting structure, such as a hook or a clip; or the like. Space is thereby formed inside the battery pack 1. The lower case 300 and the upper case 400 are simply referred to as the case. The battery module 100 and the auxiliary module 200 are positioned in the space formed by the lower case 300 and the upper case 400. The battery module 100 is positioned on the lower case 300 side. The auxiliary module 200 is positioned on the upper case 400 side. In other words, the auxiliary module 200 is positioned above the battery module 100. The lower case 300 and the upper case 400 are, for example, made from a metal material but may be made from a resin material.

The battery module 100 includes a restraining plate 60 positioned above the battery cells 10 stacked in the up-down direction. The restraining plate 60 includes a protrusion 62 that projects downward towards the battery cells 10. The lower case 300 includes a bottom surface 310 located downward. The bottom surface 310 includes a protrusion 312 that projects upward towards the battery cells 10.

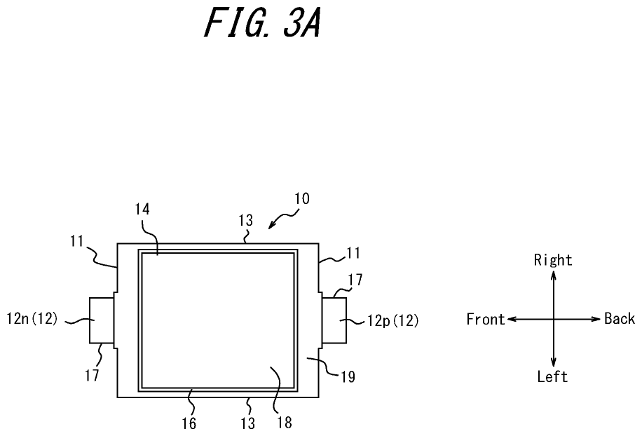

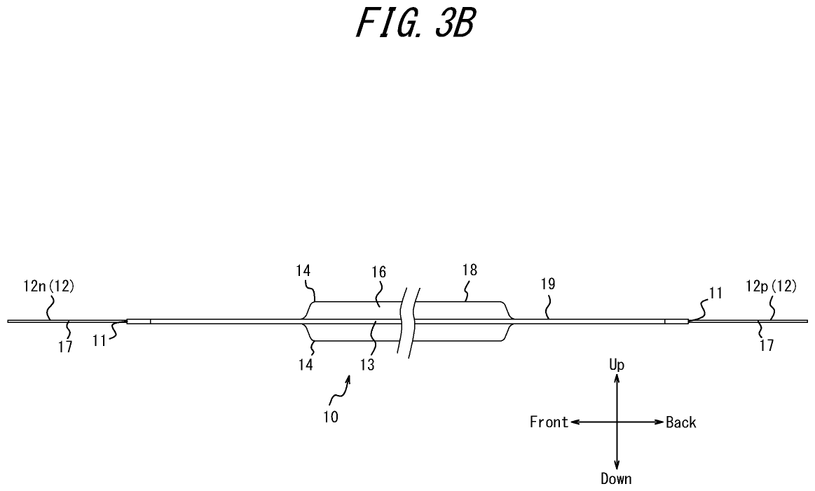

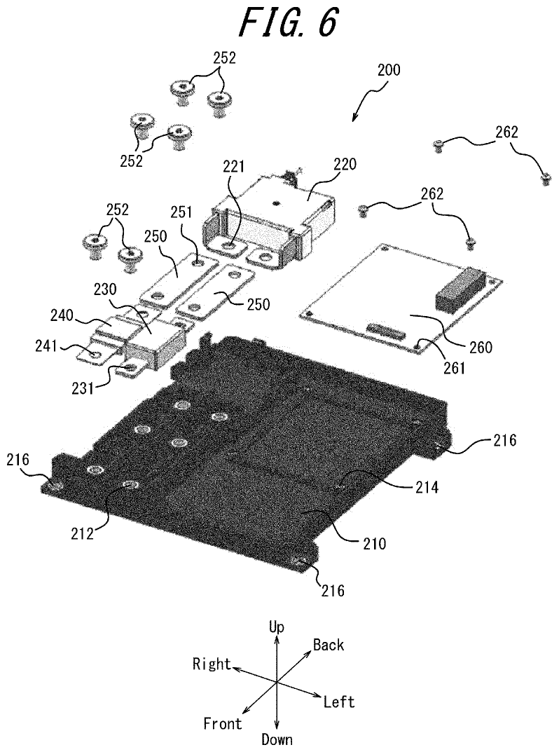

As illustrated in FIG. 2, the battery pack 1 includes a plus output terminal 410, a minus output terminal 420, a connector 430, and a gas discharge portion 440 at the upper case 400. The plus output terminal 410 and the minus output terminal 420 are electrically connected to electrode tabs 12 (see FIG. 3A and FIG. 3B) of the battery cells 10 included in the battery module 100. The connector 430 is electrically connected to a relay 220 (see FIG. 6) and the like included in the auxiliary module 200. The gas discharge portion 440 discharges gas produced inside the case from the battery cells 10 to the outside of the battery pack 1.

FIGS. 3A and 3B illustrate a configuration example of a single battery cell 10. FIG. 3A is a top view of the battery cell 10. FIG. 3B is a side view of the battery cell 10.

As illustrated in FIGS. 3A and 3B, the battery cell 10 includes an exterior member 16 and a pair of a negative electrode 12n at the front of the battery cell 10 and a positive electrode tab 12p at the back of the battery cell 10. The exterior member 16 holds an electrolyte of the battery cell 10, the cell electrodes, and the like inside. The battery cell 10 may have a flat plate shape overall. The portion where the electrolyte, the cell electrodes, and the like are held inside by the exterior member 16 is also referred to as a holding portion 18. The portion that is sealed to prevent leakage of the contents, such as the electrolyte, by the exterior member 16 being adhered, crimped, or welded is also referred to as a sealed portion 19. The thickness of the sealed portion 19 in the up-down direction is less than the thickness of the holding portion 18 in the up-down direction.

The exterior member 16 may include a laminated film. The outermost layer of the exterior member 16 may include a resin material to secure electrical insulation. In other words, the battery cell 10 may include an insulating member on the surface layer. The exterior member 16 may include an insulating layer.

The battery cell 10 includes first outer surfaces 11 on the front and back sides. The battery cell 10 includes second outer surfaces 13 on the left and right sides. The first outer surfaces 11 and the second outer surfaces 13 may be configured as the edges of the exterior member 16. The battery cell 10 includes third outer surfaces 14 on the top and bottom sides of the holding portion 18. The third outer surfaces 14 may be configured as the outermost layers of the exterior member 16. Extensions of the first outer surfaces 11, the second outer surfaces 13, and the third outer surfaces 14 intersect each other.

The negative electrode tab 12n and the positive electrode tab 12p are collectively referred to as the electrode tabs 12. The negative electrode tab 12n and the positive electrode tab 12p may protrude from the respective front and back first outer surfaces 11. The negative electrode tab 12n and the positive electrode tab 12p may be switched. The negative electrode tab 12n and the positive electrode tab 12p may project in opposite directions. The negative electrode tab 12n and the positive electrode tab 12p may project in the same direction. In an embodiment, the battery cells 10 are assumed to be stacked in the up-down direction with the pair of the positive electrode tab 12p and the negative electrode tab 12n being arranged in the front-back direction.

The electrode tabs 12 may project from the central portion of the first outer surfaces 11. The electrode tabs 12 may project substantially in parallel in the front-back direction. The electrode tabs 12 may include tab sides 17 along the projection direction. The electrode tabs 12 may be shaped as a flat plate.

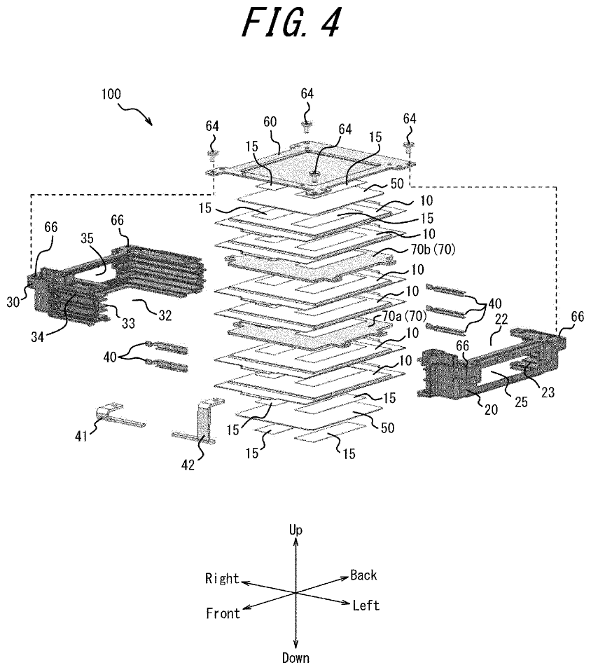

FIG. 4 is an exploded perspective view illustrating a configuration example of the battery module 100.

As illustrated in FIG. 4, the battery module 100 includes a plurality of battery cells 10 stacked in the up-down direction. The number of battery cells 10 is not limited to six. The number may be five or less, or be seven or more. The stacked battery cells 10 may be adhered by adhesive layers 15 positioned between the battery cells 10. The battery module 100 may include heat sinks 70 between the stacked battery cells 10. The heat sinks 70 may be adhered to the battery cells 10 by the adhesive layers 15.

In the plurality of stacked battery cells 10, the heat sinks 70 are sandwiched between the battery cells 10 at intervals of a plurality of battery cells 10. In greater detail, one heat sink 70a is stacked above two stacked battery cells 10. Two battery cells 10 are further stacked above the heat sink 70a. One heat sink 70b is further stacked above these two battery cells 10. Two more battery cells 10 are stacked above the heat sink 70b.

The heat sink 70 has a predetermined thickness corresponding to the amount of heat generated by the battery cells 10. A heat capacity corresponding to the amount of heat received from the battery cells 10 is thereby secured in the heat sink 70. The heat sink 70 is made of a material such as metal with high thermal conductivity to improve the dissipation of heat from the battery cells 10. At this time, the heat sink 70 is electrically insulated from the battery cells 10 by any appropriate method. The heat sink 70 may, for example, be insulated by an insulating layer forming a surface layer of the battery cell 10. The heat sink 70 may, for example, be insulated by an insulating sheet 50 separately arranged between the battery cell 10 and the heat sink 70. The heat sink 70 may, for example, be insulated by an insulating layer forming a surface layer of the heat sink 70. At this time, the heat sink 70 may be made of a metal material provided with an electrically insulating material on the surface, for example.

The adhesive layer 15 may be provided on the third outer surfaces 14 of the battery cell 10. The adhesive layer 15 may be provided on one of the two upper and lower third outer surfaces 14 of the battery cell 10. The adhesive layer 15 may include an adhesive such as a bonding agent, double-sided tape, or hotmelt. The adhesive layer 15 may, for example, be formed by a method for applying an adhesive agent to the third outer surfaces 14 of each battery cell 10 or by various other methods. The number of adhesive layers 15 positioned between the components is not limited to two as in the example in FIG. 4. The number may be one, or the number may be three or greater. The shape of the adhesive layer 15 is not limited to the rectangle in the example illustrated in FIG. 4 and may be any of a variety of other shapes.

The battery module 100 further includes a first cell case 20 and a second cell case 30. The combined configuration of the first cell case 20 and the second cell case 30 is simply referred to as a cell case. The first cell case 20 and the second cell case 30 are positioned respectively on the left side and right side of the stacked battery cells 10. When engaged with each other, the first cell case 20 and the second cell case 30 house the stacked battery cells 10 therein. In greater detail, the cell case supports the stacked battery cells 10 therein and arranges the electrode tabs 12. The first cell case 20 and the second cell case 30 may include respective separating plates 23, 33 that project inward from the side surface. The separating plates 23, 33 are positioned between the sealed portion 19 of each battery cell 10 when the first cell case 20 and the second cell case 30 are engaged.

The shape of the first cell case 20 is a substantially rectangular frame as viewed from above, and the right side is open. In other words, the first cell case 20 is substantially U-shaped, with the right side open. The shape of the second cell case 30 is a substantially rectangular frame as viewed from above, and the left side is open. In other words, the second cell case 30 is substantially U-shaped, with the left side open. The first cell case 20 and the second cell case 30 are formed as a rectangular frame, as viewed from above, by being engaged at the open sides thereof. The shape that the first cell case 20 and the second cell case 30 have when engaged is substantially square as viewed from above. The cell case houses the stacked battery cells 10 in the frame-shaped configuration. The portion corresponding to the inside of the frame as viewed from above is an opening 22 of the first cell case 20 and an opening 32 of the second cell case 30. The first cell case 20 includes the opening 22 at both ends in the stacking direction of the battery cells 10. The second cell case 30 includes the opening 32 at both ends in the stacking direction of the battery cells 10.

The first cell case 20 and the second cell case 30 may, for example, be engaged with each other by an engaging claw provided on one of the cell cases and an engaging hole provided on the other. The first cell case 20 and the second cell case 30 may, for example, each include an engaging portion projecting from any surface and be engaged by the projecting engaging portions being clamped by an elastic member such as a clip. The first cell case 20 and the second cell case 30 may, for example, be engaged by a variety of fastening structures, such as screwing. The first cell case 20 and the second cell case 30 are not limited to these examples and may be engaged by various methods. This enables the battery pack 1 to be assembled easily. Consequently, the reliability of the product can be improved.

The first cell case 20 and the second cell case 30 may include a material having a relatively high rigidity. The first cell case 20 and the second cell case 30 may, for example, be configured by a resin material or a metal material provided with an electrically insulating material, such as polyethylene terephthalate (PET) resin, on the surface.

The second cell case 30 includes slits 34 in the front and back directions. The electrode tabs 12 of the battery cells 10 pass through the slits 34 and project to the outside of the cell cases when the battery cells 10 are housed in the cell cases. The number of slits 34 corresponds to the number of battery cells 10.

The battery module 100 further includes inter-tab bus bars 40, a total plus bus bar 41, and a total minus bus bar 42 that electrically connects the electrode tabs 12 projecting outside from the cell cases. The inter-tab bus bars 40, the total plus bus bar 41, and the total minus bus bar 42 are simply referred to as bus bars.

The bus bars are made of a material having electrical conductivity. For example, the bus bars are made of a metal material, or a resin material provided with an electrically conductive material. Examples of metal materials include aluminum, copper, and the like. The material forming the bus bars is determined to ensure weldability in accordance with the material forming the electrode tabs 12. Plating to absorb laser light for laser welding to join the bus bars and the electrode tabs 12 may be applied to the surface of the bus bars.

The battery cells 10 are stacked so that the positive electrode tabs 12p and the negative electrode tabs 12n alternate. In other words, when the positive electrode tab 12p faces forward and the negative electrode tab 12n faces back in one battery cell 10, then the positive electrode tab 12p faces back and the negative electrode tab 12n faces forward in another, adjacently stacked battery cell 10.

The inter-tab bus bar 40 electrically connects the positive electrode tab 12p of one battery cell 10 and the negative electrode tab 12n of a battery cell 10 stacked adjacently. This configuration electrically connects the stacked battery cells 10 in series. When the battery cells 10 are connected in series, the positive electrode tab 12p of the battery cell 10 at the upper end or the lower end is not connected to any other battery cell 10. In an embodiment, the positive electrode tab 12p of the battery cell 10 positioned at the top is not connected to any other battery cell 10. The total plus bus bar 41 connects to the positive electrode tab 12p of the battery cell 10 positioned at the top. In this case, the negative electrode tab 12n of the battery cell 10 positioned at the bottom is not connected to any other battery cell 10. The total minus bus bar 42 connects to the negative electrode tab 12n of the battery cell 10 positioned at the bottom. As a result of this configuration, the potential difference occurring between the total plus bus bar 41 and the total minus bus bar 42 is outputted as the total voltage of the battery cells 10 electrically connected in series.

The battery pack 1 may further include a voltage detector. The voltage detector may connect electrically to the electrode tabs 12 via the bus bars and detect the terminal voltage of each battery cell 10.

The battery module 100 further includes the restraining plate 60 that restrains the battery cells 10, stacked in the up-down direction, from above. The restraining plate 60 is fastened by restraining plate fastening members 64 to fastening portions 66 provided on the first cell case 20 and the second cell case 30. The dashed lines in FIG. 4 illustrate an example of the correspondence relationship between the restraining plate fastening members 64 and the fastening portions 66.

The restraining plate 60 may include a material having a relatively high rigidity. For example, the restraining plate 60 may be made exclusively of a metal material. The configuration of the restraining plate 60 is not limited to this example. A metal material provided with an electrically insulating material, such as PET resin, on the surface may be used. The restraining plate 60 may be a substantially flat plate. The restraining plate 60 includes the protrusion 62. The protrusion 62 of the restraining plate 60 exerts pressure on the upper surface of the battery cell 10 through the openings 22, 23 of the cell cases. The stacked battery cells 10 are restrained by this configuration. The battery module 100 is therefore easy to handle. When the restraining plate 60 places pressure on the battery cell 10 through the openings 22, 23 of the cell cases, the force that exerts pressure on the battery cells 10 is less likely to act on the cell cases. Consequently, the cell cases are less likely to deteriorate or be damaged.

The battery module 100 may include the insulating sheet 50 between the battery cells 10 stacked in the up-down direction and the restraining plate 60. In other words, the restraining plate 60 may be stacked on the battery cell 10 with the insulating sheet 50 therebetween. The insulating sheet 50 may be adhered to the battery cell 10 by the adhesive layer 15. One insulating sheet 50 may abut against the upper surface of the battery cell 10 positioned at the top among the stacked battery cells 10. One insulating sheet 50 may abut against the lower surface of the battery cell 10 positioned at the bottom among the stacked battery cells 10. The insulating sheet 50 may include an electrically insulating material such as polyethylene (PE) or polypropylene (PP) resin. The insulating sheet 50 may be a substantially flat plate but is not limited to this shape. The insulating sheet 50 may be adhered to the restraining plate 60 by the adhesive layer 15. Provision of the insulating sheet 50 can improve the electrical insulation between the upper surface of the battery cell 10 and the restraining plate 60. The restraining plate 60 may be adhered to the battery cell 10 by the adhesive layer 15 without the insulating sheet 50 being present therebetween. When the restraining plate 60 is adhered to the battery cell 10 without the insulating sheet 50 being present therebetween, the surface layer or the like of the exterior member 16 of the battery cell 10 may include an insulating member layer. The insulating sheet 50 or the insulating member layer positioned between the restraining plate 60 and the battery cell 10 is also referred to as a first insulating layer. Inclusion of the first insulating layer between the restraining plate 60 and the battery cell 10 in the battery module 100 can improve the electrical insulation between the restraining plate 60 and the battery cell 10.

The first cell case 20 may include a side opening 25 on the left side. The second cell case 30 may include a side opening 35 on the right side. When the battery module 100 includes the heat sink 70, the portions projecting in the left-right direction from the heat sink 70 can project outside of the cell cases through the side openings 25, 35.

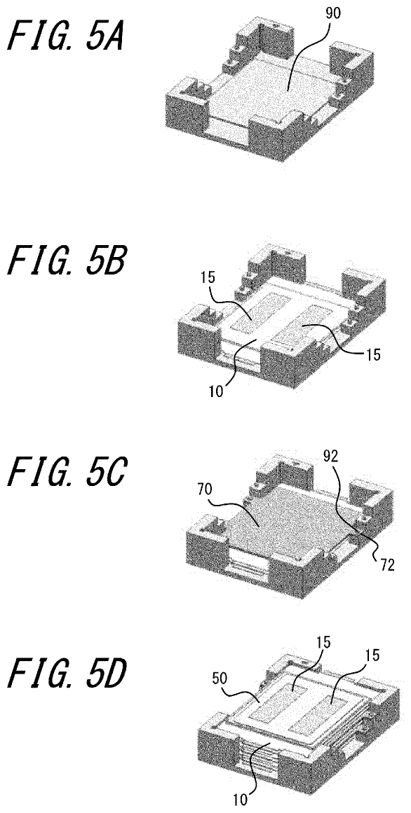

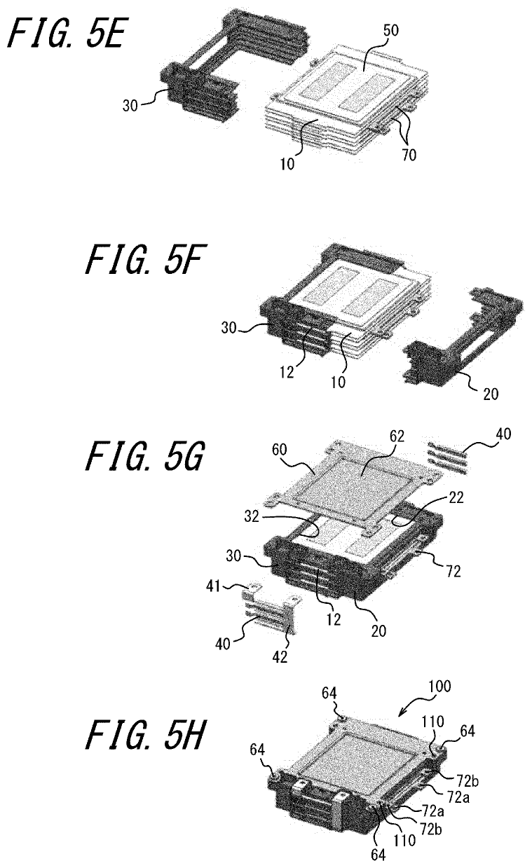

FIGS. 5A to 5H are schematic diagrams illustrating representative first to eighth steps for assembling the battery module 100. The battery module 100 may be assembled by following the example procedures illustrated in FIGS. 5A to 5H.

In the step illustrated in FIG. 5A, a jig 90 is used to assemble the battery module 100. The jig 90 may be configured so that the battery cell 10, the heat sink 70, and the like mounted on the jig 90 are aligned.

In the step illustrated in FIG. 5B, a battery cell 10 is mounted on the jig 90. The jig 90 may have inner surfaces corresponding to the shape of the first outer surfaces 11 and the second outer surfaces 13 of the battery cell 10 so that the battery cell 10 is mounted in an aligned state. The jig 90 may have a shape corresponding to the electrode tabs 12 projecting from the central portion of the first outer surfaces 11 of the battery cell 10. The adhesive layer 15 may be provided on the upper surface and/or lower surface of the battery cell 10.

In the step illustrated in FIG. 5C, a heat sink 70 is mounted on the jig 90. The jig 90 may include a boss 92 and a step to enable the heat sink 70 and the like to be aligned and mounted. The heat sink 70 may include a projection and a hole 72 at the edge for use when fastening the battery module 100 to the lower case 300. The heat sink 70 may be aligned by the projection abutting against the step of the jig 90 and the hole 72 fitting on the boss 92 of the jig 90.

In the step illustrated in FIG. 5D, an insulating sheet 50 may be further mounted on the upper surface of the stacked battery cells 10. An adhesive layer 15 may be provided on the upper surface of the insulating sheet 50.

In the step illustrated in FIG. 5E, the second cell case 30 is inserted onto a configuration in which at least the battery cells 10 are stacked. The separating plates 33 of the second cell case 30 are inserted at this time between the sealed portions 19 of the stacked battery cells 10. In this stacked configuration of battery cells 10, the battery cells 10, or the battery cells 10 and other components, are adhered together by the adhesive layers 15. Therefore, this configuration can remain aligned even when removed from the jig 90.

In the step illustrated in FIG. 5F, the first cell case 20 is inserted from the opposite side of the second cell case 30 onto the configuration in which the battery cells 10 are stacked. At this time, the separating plates 23 of the first cell case 20 are inserted between the sealed portions 19 of the stacked battery cells 10. The electrode tabs 12 of the battery cells 10 project outside from the slits 34 of the second cell case 30.

In the step illustrated in FIG. 5G, the inter-tab bus bars 40, the total plus bus bar 41, and the total minus bus bar 42 are electrically connected to the electrode tabs 12. The bus bars and the electrode tabs 12 may, for example, be electrically connected by welding or the like. When the positive electrode tab 12p and the negative electrode tab 12n of adjacent battery cells 10 are joined by welding the inter-tab bus bars 40, the battery cells 10 remain aligned, enabling the tabs to be joined accurately.

Furthermore, the restraining plate 60 is attached from the upper surface to the configuration in which the stacked battery cells 10 are housed in the cell cases. The protrusion 62 of the restraining plate 60 abuts through the openings 22, 23 of the cell cases against the upper surface of the configuration in which the battery cells 10 are stacked. The restraining plate 60 may be adhered by the adhesive layers 15 to the configuration in which the battery cells 10 are stacked.

In the step illustrated in FIG. 5H, the restraining plate 60 may be fastened to the cell cases by the restraining plate fastening members 64. Assembly of the battery module 100 is completed by the restraining plate 60 being fastened to the cell cases.

As illustrated in FIG. 5H, the fixing points of the heat sinks 70 and the cell cases to the lower case 300 are disposed along the same side surface of the cell cases in the assembled battery module 100. In greater detail, a pair of holes 72a of the heat sink 70a, a pair of holes 72b of heat sink 70b, and a pair of fastening portions 110 of the cell cases are arranged on substantially the same surface along the left and right sides of the cell cases.

The fixing points of the heat sink 70b positioned at the side of an opening 350 (see FIG. 1) formed in the lower case 300 are arranged farther outward along the left and right sides of the cell cases inside the lower case 300 than fixing points of the other heat sink 70a positioned on the opposite side from the opening 350. The fixing points of the cell cases are arranged further outward on the inside of the lower case 300 than the fixing points of the heat sinks 70. In greater detail, the pair of holes 72b of the heat sink 70b disposed on the upper side are arranged farther outward in the front-back direction than the pair of holes 72a of the heat sink 70a disposed on the lower side. The pair of fastening portions 110 of the cell case are disposed farther outward in the front-back direction than the pair of holes 72b of the heat sink 70b disposed on the upper side.

Assembly of the battery module 100 following the example steps illustrated in FIGS. 5A to 5H can improve the alignment accuracy of the electrode tabs 12 of the adjacently stacked battery cells 10. Consequently, the electrode tabs 12 and the bus bars can easily be joined with a high degree of accuracy, and the reliability of the battery pack 1 can be improved.

The stacked components, such as the battery cells 10, the heat sinks 70, the insulating sheets 50, and the restraining plate 60, are adhered by the adhesive layers 15, which can improve the durability when the battery module 100 experiences vibrations, shocks, or the like. For example, when the battery pack 1 including the battery module 100 is mounted in a vehicle, the relative displacement of components in the battery module 100 due to vibrations, shocks, or the like when the vehicle travels can be reduced. As a result of the components of the battery module 100 being adhered, the components are less prone to damage when experiencing vibrations, shocks, or the like.

When the first cell case 20 and the second cell case 30 respectively include the separating plates 23, 33 positioned between the sealed portions 19 of the battery cells 10, it becomes easier to insulate the battery cells 10 from each other. For example, even if the battery cells 10 deteriorate over time and deform, the adjacently stacked battery cells 10 tend not to come into contact with each other.

When the cell cases are formed by a metal material with an electrically insulating material provided on the surface, a resin material, or the like, the electrical components and the like located inside the battery pack 1 and the battery cells 10 can be electrically insulated from each other.

Furthermore, even if the lower case 300 and the upper case 400 of the battery pack 1 are metal, insulation can be secured between the battery cells 10 and the electrical components and the like located outside the battery pack 1. If the lower case 300 and the upper case 400 are made of a resin material, insulation can similarly be secured between the battery cells 10 and the electrical components and the like located outside the battery pack 1 even when the cell cases are made of a metal material.

FIG. 6 is an exploded perspective view illustrating a configuration example of the auxiliary module 200.

As illustrated in FIG. 6, the auxiliary module 200 includes an auxiliary pedestal 210, a relay 220, a current sensor 230, a fuse 240, and a substrate 260. The current sensor 230 includes fastening holes 231 at the ends and is fastened to fastening portions 212 of the auxiliary pedestal 210 by fastening members 252. The fastening hole 231 at one end of the current sensor 230 is fastened together with a fastening hole 251 of a copper bus bar 250 electrically connected to the relay 220.

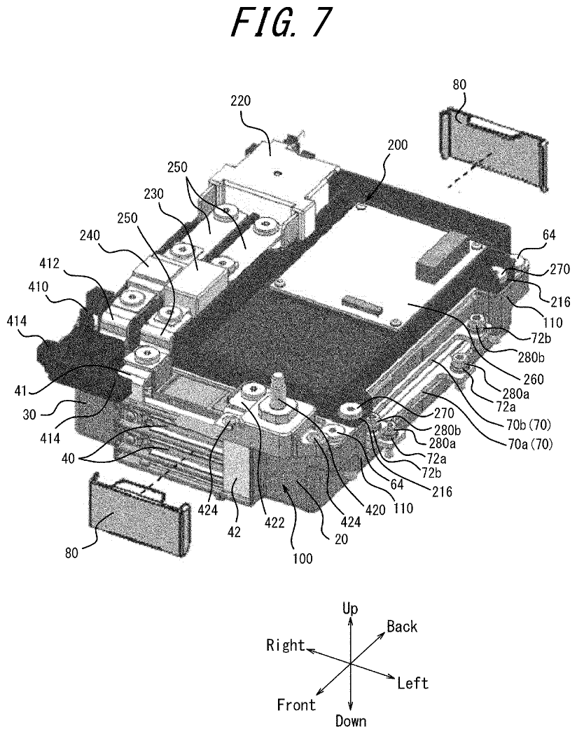

The relay 220 includes fastening holes 221 at the ends and is fastened to the fastening portions 212 of the auxiliary pedestal 210 by the fastening members 252. The fastening hole 221 at one end of the relay 220 is fastened together with a fastening hole 251 of the copper bus bar 250 electrically connected to the current sensor 230. The fastening hole 221 at the other end of the relay 220 is fastened together with a fastening hole 251 of the copper bus bar 250 electrically connected to the fuse 240. The fuse 240 includes fastening holes 241 at the ends and is fastened to the fastening portions 212 of the auxiliary pedestal 210 by the fastening members 252. The fastening hole 241 at one end of the fuse 240 is fastened together with the fastening hole 251 of the copper bus bar 250 electrically connected to the relay 220. The substrate 260 includes fastening holes 261 at its four corners, for example, and is fastened to the fastening portions 214 of the auxiliary pedestal 210 by fastening members 262. The auxiliary pedestal 210 includes the fastening holes 216. When the auxiliary module 200 is housed together with the battery module 100 in the lower case 300, the auxiliary module 200 is fastened to fastening portions 340 (see FIG. 1) of the lower case 300 by module fastening members 270 (see FIG. 7) passing through the fastening holes 216.

FIG. 7 is a perspective view illustrating an example of assembling the battery module 100 and the auxiliary module 200.

As illustrated in FIG. 7, the auxiliary pedestal 210 of the auxiliary module 200 is fastened to the first cell case 20 and the second cell case 30 by the module fastening members 270. The module fastening members 270 can fasten the auxiliary module 200 and the battery module 100 together to the fastening portions 340 of the lower case 300 (see FIG. 1). The current sensor 230 can electrically connect to the copper bus bar 250, which is electrically connected to the total plus bus bar 41, at a different terminal than the side electrically connected to the relay 220.

The battery pack 1 further includes the plus output terminal 410 and the minus output terminal 420. The fuse 240 is electrically connected to a plus output terminal bus bar 412, which is electrically connected to the plus output terminal 410, at a different terminal than the side electrically connected to the relay 220. In other words, the plus output terminal 410 is electrically connected to the total plus bus bar 41 via the fuse 240, the relay 220, and the current sensor 230, which are connected in series. The minus output terminal 420 is electrically connected to the total minus bus bar 42 via a minus output terminal bus bar 422. The plus output terminal 410 may be fastened to a fastening portion 330 of the lower case 300 (see FIG. 1) by screwing or the like at a fastening hole 414. The minus output terminal 420 may be fastened to the lower case 300 by screwing or the like at a fastening hole 424.

The battery pack 1 may further include a bus bar cover 80 that covers the inter-tab bus bars 40, the total plus bus bar 41, and the total minus bus bar 42. By the bus bar cover 80 covering the bus bars, the reliability of the battery pack 1 can be further improved, since the electrical insulation between the bus bars and the lower case 300 can be secured even when the battery pack 1 experiences shocks such as collisions.

The relay 220 functions as a switching element that connects or disconnects the battery cells 10 and the plus output terminal 410.

The current sensor 230 detects the magnitude of current flowing from the battery cells 10 to the plus output terminal 410. The current sensor 230 may output the detected magnitude of the current to the substrate 260.

The fuse 240 may include a fuse body, a housing made of insulating resin for holding the fuse body, and a cover made of insulating resin for covering the housing. The fuse 240 fuses when overcurrent occurs.

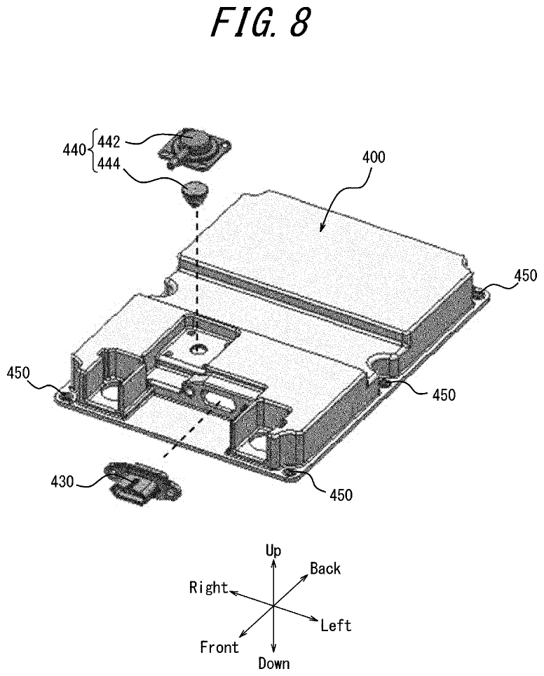

The substrate 260 may include a battery management system (BMS). The BMS is also referred to as a battery controller. The BMS may include at least one processor. The BMS may be communicably connected to the current sensor 230 and acquire the result of current detection from the current sensor 230. The BMS may be communicably connected to the relay 220 and output information to control opening and closing of the relay 220. The BMS may be electrically connected to the inter-tab bus bars 40 and detect the potential of the inter-tab bus bars 40. The BMS may be communicably connected to a sensor for detecting the potential of the inter-tab bus bars 40 and acquire the result of detecting the potential of the inter-tab bus bars 40. The BMS may output information related to the battery cells 10 to the outside via the connector 430 (see FIG. 8).

When the auxiliary module 200 is housed together with the battery module 100 in the lower case 300, the auxiliary module 200 is fastened to fastening portions 340 (see FIG. 1) of the lower case 300 by the module fastening members 270 passing through the fastening holes 216 and the fastening portions 110. At this time, the fixing points of the cell cases, specifically the fixing points between the module fastening members 270 and the fastening portions 340, are arranged in a central region of the cell cases in the stacking direction of the battery cells 10.

The heat sinks 70 projecting from the cell case are fixed to the lower case 300. In greater detail, the heat sink 70a is fastened to fastening portions 360a (see FIG. 1) of the lower case 300 by heat sink fastening members 280a passing through the pair of holes 72a of the heat sink 70a. Similarly, the heat sink 70b is fastened to fastening portions 360b (see FIG. 1) of the lower case 300 by heat sink fastening members 280b passing through the pair of holes 72b of the heat sink 70b. The method of fixing the heat sinks 70 to the lower case 300 is not limited to fastening using fastening members such as screws. The fastening method may be a method using adhesive, a method using welding, or any combination of the above-described methods. The heat sinks 70 may be fixed to the lower case 300 via a heat dissipation agent. Examples of heat dissipation agents include paste, liquid such as adhesives, and an elastic sealant.

When the battery module 100 is housed in the lower case 300 together with the auxiliary module 200, the heat sinks 70 are fastened to the lower case 300 in order starting with the heat sink 70 positioned farther on the opposite side from the opening 350 (see FIG. 1) of the lower case 300. Subsequently, the cell cases are fixed to the lower case 300. In other words, the heat sink 70a, the heat sink 70b, and the cell cases are fixed in this order to the lower case 300.

FIG. 8 is an exploded perspective view illustrating a configuration example of the upper case 400.

As illustrated in FIG. 8, the upper case 400 includes the connector 430 and the gas discharge portion 440. The connector 430 is communicably connected to the substrate 260 of the auxiliary module 200. The connector 430 may be connectable to an external circuit, such as an electric control unit (ECU) of the vehicle in which the battery pack 1 is mounted.

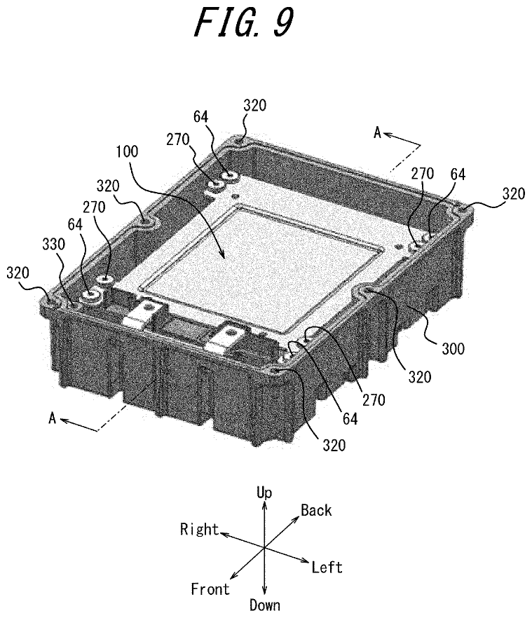

The upper case 400 includes fastening portions 450 that are fastened to the fastening portions 320 (see FIG. 9) of the lower case 300. The fastening portions 320 of the lower case 300 and the fastening portions 450 of the upper case 400 may be fastened by screwing or the like or may be fastened by elastic members such as clips. The case configured by the upper case 400 and the lower case 300 being fastened together can protect the battery module 100 by surrounding the battery module 100.

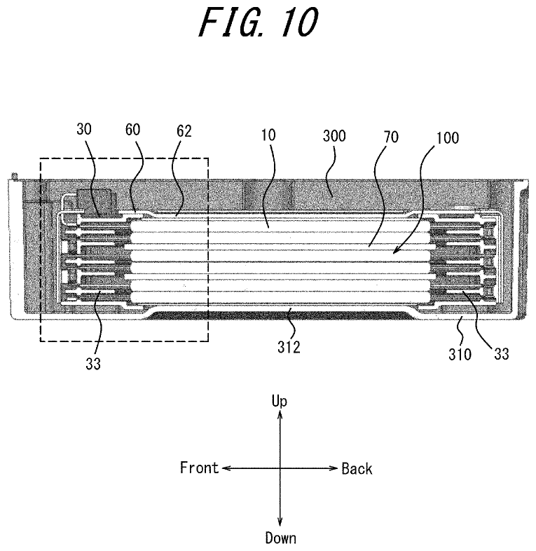

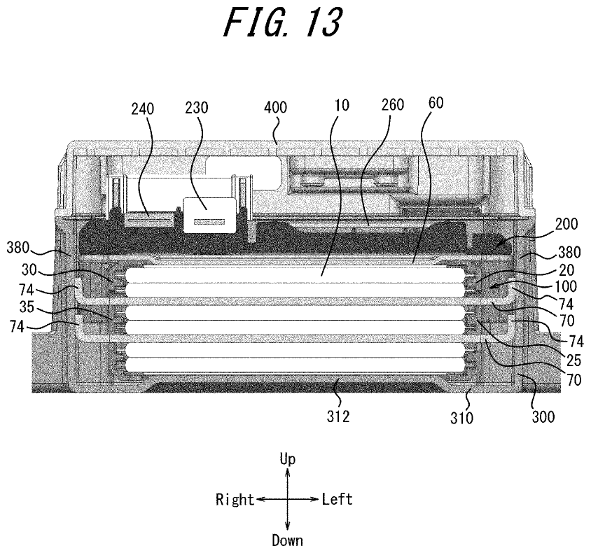

The battery cells 10 may deteriorate over time due to repeated charging and discharging. Gas caused by decomposition or volatilization of electrolytes may be produced inside the battery cells 10 along with deterioration of the battery cells 10 over time. If the pressure of the gas inside the battery cells 10 exceeds a predetermined value, the gas may be released to the outside from a portion of the sealed portions 19 of the battery cells 10. The gas released from inside the battery cells 10 may accumulate in the space inside the battery pack 1 that is surrounded by the lower case 300 and the upper case 400. The gas accumulated in the space inside the battery pack 1 can pass through the gas discharge portion 440 of the upper case 400 to be discharged outside of the battery pack 1. The gas discharge portion 440 is provided on the upper surface of the upper case 400 but is not limited to this position and may be provided on a side surface of the upper case 400 or on the bottom surface 310 (see FIG. 10) or a side surface 380 (see FIG. 13) of the lower case 300.

The gas discharge portion 440 includes a gas cover 442 and a breather 444. The gas cover 442 can cover the breather 444 to protect the breather 444 from shocks or the like from the outside. The breather 444 includes an internal pressure adjustment membrane, which has breathability along with water resistance and dust resistance, in a gas discharge path. By the gas discharge portion 440 including the breather 444, gas accumulating in the space inside the battery pack 1 is discharged outside the battery pack 1 while water, dust, or the like is impeded from entering into the battery pack 1 from outside the battery pack 1. Consequently, the reliability of the battery pack 1 can be improved.

FIG. 9 is a perspective view illustrating a configuration example of the battery module 100 being housed in the lower case 300.

As illustrated in FIG. 9, the battery module 100 is fastened to the fastening portions 340 (see FIG. 1) of the lower case 300 while the battery module 100 is housed in the lower case 300. When the auxiliary module 200 is mounted in the upper portion of the battery module 100, the auxiliary pedestal 210 and the cell case are fastened together to the fastening portions 340 of the lower case 300 by the module fastening members 270 (see FIG. 7).

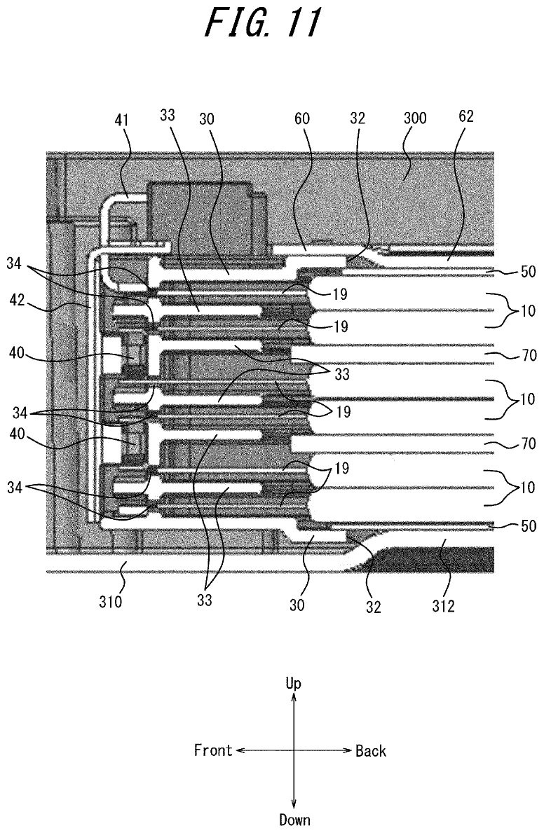

FIG. 10 is a cross-section along the A-A line in FIG. 9. FIG. 11 is an enlargement of the portion surrounded by a dashed line in FIG. 10.

As illustrated in FIGS. 10 and 11, the lower case 300 includes the bottom surface 310 at the lower side. When the battery module 100 is housed in the lower case 300, pressure is exerted on the stacked battery cells 10 by the bottom surface 310 positioned below and the restraining plate 60 positioned above. In other words, the bottom surface 310 of the lower case 300 exerts pressure on the battery cells 10 from the opposite side from which the restraining plate 60 exerts pressure on the battery cells 10. The stacked battery cells 10 may be considered to be sandwiched between the bottom surface 310 and the restraining plate 60. The stacked battery cells 10 can be housed in a stable state in the lower case 300 by being sandwiched. A member simply for exerting pressure on the battery cells 10 from below can be omitted as a result of the bottom surface 310 of the lower case 300 having the function of exerting pressure on the battery cells 10 from below. Consequently, the reliability of the holding structure of the battery cells 10 can be improved while the battery pack 1 is reduced in size, weight, and cost.

The bottom surface 310 may abut against the lower surface of the battery cell 10 via the insulating sheet 50. The insulating sheet 50 may be adhered to the bottom surface 310 by the adhesive layer 15. Provision of the insulating sheet 50 can improve the electrical insulation between the lower surface of the battery cell 10 and the bottom surface 310 of the lower case 300. The bottom surface 310 may be adhered to the battery cell 10 by the adhesive layer 15 without the insulating sheet 50 being present therebetween. When the bottom surface 310 is adhered to the battery cell 10 without the insulating sheet 50 being present therebetween, the surface layer or the like of the exterior member 16 of the battery cell 10 may include an insulating member layer. The insulating sheet 50 or the insulating member layer positioned between the bottom surface 310 and the battery cell 10 is also referred to as a second insulating layer. Inclusion of the second insulating layer between the bottom surface 310 and the battery cell 10 in the battery module 100 can improve the electrical insulation between the battery cell 10 and the lower case 300.

The bottom surface 310 includes a protrusion 312 that projects upward. The protrusion 312 can pass through the openings 22, 32 of the cell cases to abut against a predetermined area including the center of the lower surface of the battery cell 10. The protrusion 62 of the restraining plate 60 positioned above the battery module 100 can pass through the openings 22, 32 of the cell cases to abut against a predetermined area including the center of the upper surface of the battery cell 10. The protrusion 62 may abut against the upper surface of the battery cell 10 via another component, such as the insulating sheet 50. When the battery module 100 is housed in the lower case 300, the stacked battery cells 10 are sandwiched between the protrusion 312 positioned below and the protrusion 62 positioned above. The stacked battery cells 10 are firmly restrained by being sandwiched from both above and below. Pressure is exerted on the stacked battery cells 10 by the protrusion 62 and the protrusion 312 in predetermined regions including the centers of each of the upper and lower surfaces. A larger pressure can be exerted at the central portion of the upper and lower surfaces of the holding portions 18 than at the peripheral portion near the sealed portions 19 of the battery cells 10.

The battery cells 10 may deteriorate over time due to repeated charging and discharging. Gas caused by decomposition or volatilization of electrolytes may be produced inside the battery cells 10 along with deterioration of the battery cells 10 over time. The gas produced inside the battery cells 10 can cause the battery cells 10 to swell. The stacked battery cells 10 are less likely to swell in the stacking direction as a result of pressure being exerted from the upper and lower surfaces by the protrusion 62 of the restraining plate 60 and the protrusion 312 of the bottom surface 310.

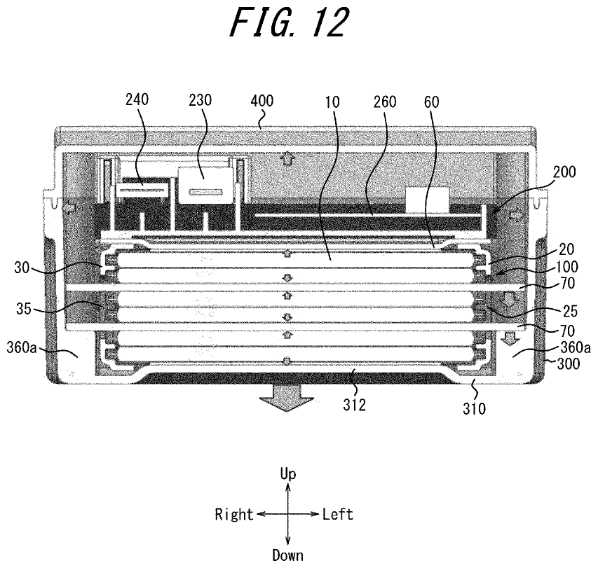

FIG. 12 is a cross-section along the B-B line in FIG. 2. Heat dispersion from a laminate including the plurality of stacked battery cells 10 is described with reference to FIG. 12. A depiction of the heat sink fastening members 280a that fasten the heat sinks 70 to the fastening portions 360a is omitted in FIG. 12.

Heat generated in the battery cells 10 adjacent to the heat sinks 70 is transmitted outward to the left and right and through the heat sinks 70. Consequently, heat is transmitted to the fixing points of the heat sinks 70 and the lower case 300 and escapes to the lower case 300 through the fixing points. The heat produced in the battery cell 10 located in the uppermost portion of the laminate is released to the inside of the case through the restraining plate 60. The heat released to the inside of the case from the restraining plate 60 escapes mainly to the upper case 400 by convection. The heat produced in the battery cell 10 located in the lowermost portion of the laminate escapes to the lower case 300 at the protrusion 312 of the lower case 300. The heat that escapes to the case by the above process is further released to the outside. For example, when the above-described case is made of a metal material or a resin material formed integrally with a metal material, heat dissipates more efficiently from the case.

The above-described battery module 100 according to an embodiment enables heat from the stacked battery cells 10 to dissipate efficiently. In greater detail, heat produced in the battery cells 10 escapes to the lower case 300 through the fixing points of the heat sinks 70 as a result of the heat sinks 70 being fixed to the lower case 300. In the battery pack 1 that houses the battery module 100 in this way, the case becomes the final heat dissipation portion. An additional component with the function of heat dissipation is therefore unnecessary. Accordingly, the battery pack 1 can be kept from increasing in size.

Insulation properties are improved by the heat sinks 70 and the battery cells 10 being electrically insulated from each other. Consequently, the product reliability of the battery module 100 and the battery pack 1 can be improved.

The thermal conductivity at the fixing points of the heat sinks 70 and the lower case 300 is improved by the heat sinks 70 and lower case 300 being fixed by at least one of fastening with screws, adhesion, and welding. Consequently, heat from the stacked battery cells 10 is dissipated more efficiently.

The thermal conductivity at the fixing points of the heat sinks 70 and the lower case 300 is further improved by the heat sinks 70 being fixed to the lower case 300 via a heat dissipation agent. Consequently, heat from the stacked battery cells 10 is dissipated more efficiently.

The battery module 100 is fixed at a position closer to the center of gravity of the entire battery module 100 by the fixing points of the cell cases being disposed in the central region of the cell cases. This enables the battery module 100 to be fixed in a more balanced way to the lower case 300. Accordingly, when the battery pack 1 including the battery module 100 is mounted in a vehicle, this configuration improves resistance to vibrations, shocks, or the like while the vehicle is traveling.

By the fixing points of the heat sinks 70 and the cell cases to the lower case 300 being arranged along the same side surface of the cell cases, the layout improves and the battery pack 1 is reduced in size. The fixing points are arranged near each other, thereby facilitating the operation to fix the heat sinks 70 and the cell cases to the lower case 300. This improves operability during assembly of the battery pack 1.

The pair of holes 72a of the heat sink 70a, the pair of holes 72b of the heat sink 70b, and the pair of fastening portions 110 of the cell cases are arranged in order from the inside to the outside in the front-back direction and are fixed in order. Pressure is thereby exerted uniformly on each battery cell 10. In greater detail, when components are fixed to the lower case 300 in order starting with the heat sink 70a positioned farther on the opposite side from the opening 350, the pressure on each battery cell 10 is more uniform than when an entire laminate including a plurality of battery cells 10 is fixed at once. Finally, each battery cell 10 is pressed uniformly and fixed by the restraining plate 60 arranged on the upper surface of the battery module 100. The amount of displacement of the battery cells 10 due to pressure is also small, thereby suppressing the mechanical load acting on the fixing points. Consequently, the holes 72a, 72b and the fastening portions 110 can be reduced in size, reducing the battery pack 1 in size. Additionally, variation in the positions of the battery cells 10 at the time of fixing can be reduced, thereby improving the reliability of the battery module 100.

By the heat sinks 70 being sandwiched between the battery cells 10 at intervals of a plurality of battery cells 10, the number of components is reduced, enabling a reduction in size, weight, and cost of the battery pack 1. Consequently, the productivity of the battery pack 1 improves.

The restraining plate 60 and the bottom surface 310 exert pressure on the stacked battery cells 10 through the openings 22, 23 of the cell cases. In other words, the cell cases are not pressed directly by the restraining plate 60 and the bottom surface 310. The cell cases are less prone to warping by not being pressed. Consequently, the cell cases are less prone to damage.

The rigidity of the restraining plate 60 can be improved by the restraining plate 60 being made of a metal material. Consequently, the battery cells 10 are less likely to swell in the stacking direction of the battery cells 10, and the position of the battery cells 10 in the up-down direction can be restricted. The electrical conductivity can be improved by the restraining plate 60 including a resin material or a metal material that is provided with an electrically insulating material. When the restraining plate 60 is made of a resin material, the battery pack 1 can be reduced in weight and manufactured at low cost.

By pressure being exerted on the battery cell 10 in the central region of the upper surface and lower surface of the holding portion 18, gas produced inside the battery cell 10 can be collected in the surrounding portion near the sealed portion 19. When the pressure of gas produced inside the battery cell 10 exceeds a predetermined value, the gas can be discharged outside the battery cell 10 from the sealed portion 19. The gas is more easily discharged outside the battery cell 10 by collecting in the surrounding portion near the sealed portion 19. In other words, by pressure being exerted on the battery cell 10 in the central region of the upper surface and lower surface of the holding portion 18, the gas is more easily discharged outside the battery cell 10. Consequently, the reliability of the battery cell 10 can be improved.

By the battery module 100 including the insulating sheet 50, electrical insulation can be secured between the restraining plate 60 and the internal battery cells 10.

The symmetry of the cell cases can be improved by the positive electrode tab 12p and the negative electrode tab 12n of the battery cell 10 projecting in opposite directions along the front-back direction. The cell cases can thereby be formed in a well-balanced manner.

As illustrated in FIG. 13, the heat sinks 70 may include curved ends 74. The curved ends 74 may abut against the side surfaces 380 of the lower case 300. This configuration enables heat dissipation from the heat sinks 70 to the lower case 700 even when there is no space to fasten the heat sinks 70 to the lower case 300.

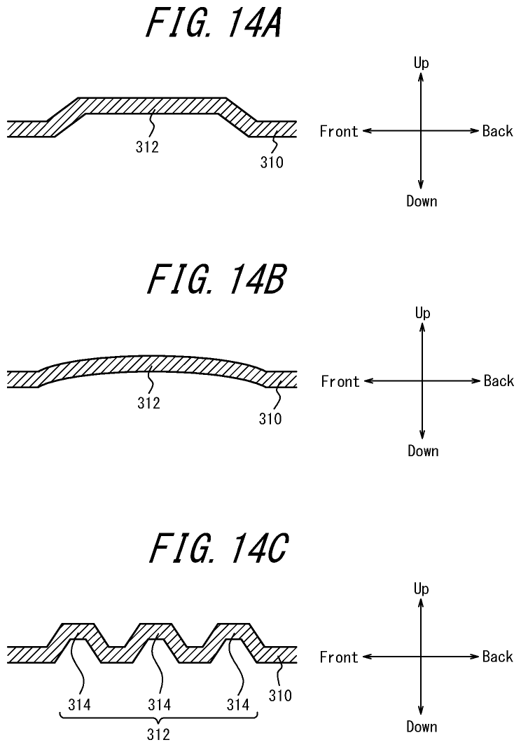

As illustrated in FIGS. 14A, 14B, 14C, the cross-sectional shape of the protrusion 312 in the bottom surface 310 of the lower case 300 may be any of various shapes. The cross-sectional shape of the protrusion 312 is not limited to the examples illustrated in FIGS. 14A, 14B, 14C and may be any of various other shapes. The cross-sectional shape of the protrusion 312 may be an offset shape such that a portion of the surface protrudes uniformly upward, as illustrated in FIG. 14A. When a portion of the surface protrudes uniformly, the protrusion 312 can exert pressure on the entire lower surface of the battery cell 10. The shape of the protrusion 312 can be determined appropriately to control the force applied to the battery cell 10.

The cross-sectional shape of the protrusion 312 may be a camber shape such that the amount of upward protrusion gradually increases from the edges towards the center, as illustrated in FIG. 14B. The amount of protrusion is greatest at the center in the camber shape. The greater amount of protrusion at the center than at the edges makes it easier for the protrusion 312 to press the central region of the bottom surface of the battery cell 10. Furthermore, the gradual increase in the upward amount of protrusion from the edges towards the center makes it easier to control the magnitude of pressure on the battery cell 10. This configuration makes the gas produced inside the battery cell 10 less likely to accumulate in the center of the battery cell 10 and more likely to move to the periphery of the battery cell 10. An increase in the internal resistance of the battery cell 10 can be suppressed as a result of the gas moving to the periphery inside the battery cell 10. In other words, gas is less likely to be present between the cell electrodes provided inside the battery cell 10 as a result of the gas moving to the periphery inside the battery cell 10. This can achieve stable charging/discharging characteristics.

The cross-sectional shape of the protrusion 312 may be a shape including a plurality of ribs 314 that project upward, as illustrated in FIG. 14C. The shape such that the protrusion 312 includes the ribs 314 is also referred to as a ribbed shape. When the protrusion 312 includes the plurality of ribs 314, the rigidity of the protrusion 312 can be increased. This increase in the rigidity of the protrusion 312 makes the bottom surface 310 less prone to deformation when pressure is exerted on the bottom surface of the battery cell 10 and enables pressure to be exerted stably on the entire bottom surface of the battery cell 10.

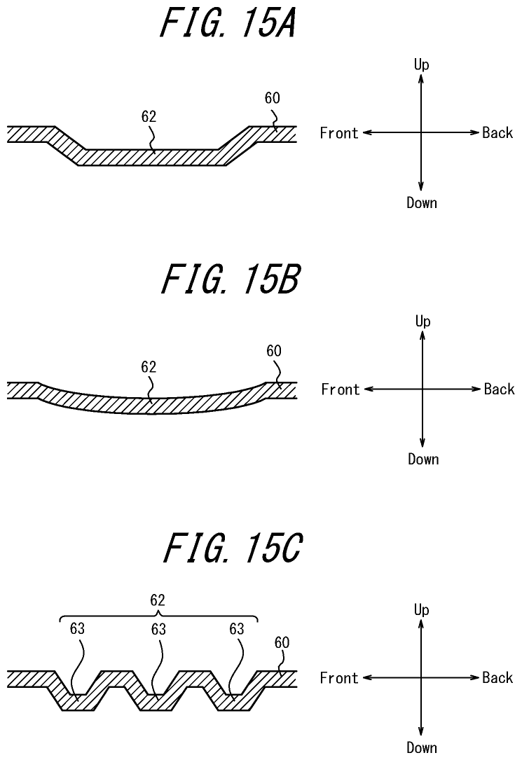

As illustrated in FIGS. 15A, 15B, 15C, the cross-sectional shape of the protrusion 62 in the restraining plate 60 may be any of various shapes. The cross-sectional shape of the protrusion 62 is not limited to the examples illustrated in FIGS. 15A, 15B, 15C and may be any of various other shapes. The cross-sectional shape of the protrusion 62 may be an offset shape, as illustrated in FIG. 15A. The cross-sectional shape of the protrusion 62 may be a camber shape, as illustrated in FIG. 15B. The cross-sectional shape of the protrusion 62 may be a shape including a plurality of ribs 63 that project downward, as illustrated in FIG. 15C. The advantages of each cross-sectional shape of the protrusion 62 are the same or similar to the advantages of each shape of the protrusion 312 of the bottom surface 310.

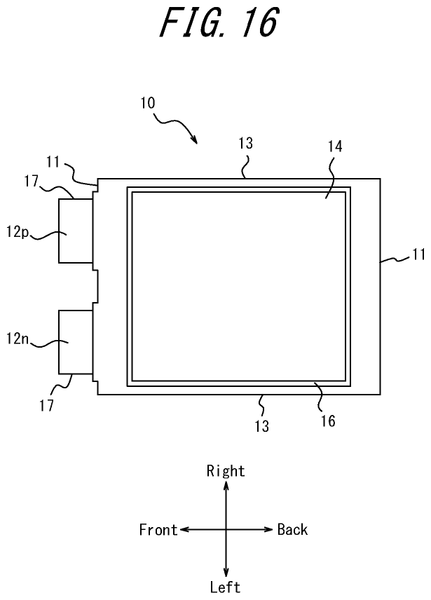

The positive electrode tab 12p and the negative electrode tab 12n of the battery cell 10 have been described as protruding in opposite directions along the front-back direction but are not limited to this example. As illustrated in FIG. 16, the positive electrode tab 12p and the negative electrode tab 12n may be formed on the same surface. In this case, the positive electrode tab 12p and the negative electrode tab 12n may be arranged side-by-side and project forward from the first outer surface 11. The first cell case 20 and the second cell case 30 may have any configuration capable of housing the battery cell 10 illustrated in FIG. 16 in a stacked state. The plurality of battery cells 10 may be stacked so that the positions of the positive electrode tabs 12p and the negative electrode tabs 12n in the left-right direction differ between adjacent battery cells 10.

When the positive electrode tabs 12p and the negative electrode tabs 12n are formed on the same surface, the slits 34 of the second cell case 30 through which the electrode tabs 12 are passed can be formed together on one outer surface, such as the front surface. The number of steps for assembling the battery module 100 can be reduced by the electrode tabs 12 projecting from one surface. Consequently, the productivity of the battery pack 1 can be improved. Furthermore, by the electrode tabs 12 projecting only from one outer surface, the outer surface on the opposite side can be made flatter. This enables the length in the front-back direction of the battery module 100 to be shortened by an amount equal to the projection length of the positive electrode tab 12p or the negative electrode tab 12n from the cell case. The battery pack 1 can thereby be reduced in size overall.

In the battery pack 1, the insulating sheet 50 and the restraining plate 60 may be provided at only one end in the up-down direction of the first cell case 20 and the second cell case 30. This can reduce the number of components in the battery pack 1. Consequently, the productivity of the battery pack 1 can be improved.

It will be apparent to a person of ordinary skill in the art that the present disclosure can be embodied in forms other than the above embodiment without departing from the spirit or essential features of the present disclosure. Accordingly, the description above is only a non-limiting example. The scope of the present disclosure is defined not by the description above, but by the appended claims. Among all possible modifications, the modifications within the range of equivalents are to be considered as encompassed by the claims.

For example, the shape, arrangement, number, and the like of each above-described component are not limited to the above description or the matter illustrated in the drawings. The shape, arrangement, number, and the like of each component may be freely configured as long as each component can achieve its function.

For example, the method of assembling the battery module 100 is not limited to the above-described method. The method of assembling the battery module 100 may be any method of assembly enabling the functions of the battery module 100 to be achieved. For example, each step in the above-described method of assembling the battery module 100 may be reordered in any logically consistent manner, a plurality of steps may be combined into one, or a single step may be divided.

The direction in which the first cell case 20 and the second cell case 30 are engaged is not limited to the left-right direction. The first cell case 20 and the second cell case 30 may be engaged along any direction as long as the first cell case 20 and the second cell case 30 can achieve their functions.

The restraining plate 60 may also be disposed on the bottom surface side of the battery module 100. The battery cells 10 are thereby sandwiched by highly rigid restraining plates 60 from both above and below, further improving the pressure retention.

### REFERENCE SIGNS LIST

1 Battery pack
10 Battery cell
11 First outer surface
12 (12p, 12n) Electrode tab (positive electrode tab, negative electrode tab)
13 Second outer surface
14 Third outer surface
15 Adhesive layer
16 Exterior member
17 Tab side
18 Holding portion
19 Sealed portion
20 First cell case
22 Opening
23 Separating plate
25 Side opening
30 Second cell case
32 Opening
33 Separating plate
34 Slit
35 Side opening
40 Inter-tab bus bar
41 Total plus bus bar
42 Total minus bus bar
50 Insulating sheet
60 Restraining plate
62 Protrusion
64 Restraining plate fastening member
66 Fastening portion
70, 70a, 70b Heat sink
72, 72a, 72b Hole
74 End
80 Bus bar cover
90 Jig
92 Boss
100 Battery module
110 Fastening portion
200 Auxiliary module
210 Auxiliary pedestal
212, 214 Fastening portion
216 Fastening hole
220 Relay
221 Fastening hole
230 Current sensor
231 Fastening hole
240 Fuse
241 Fastening hole
250 Copper bus bar
251 Fastening hole
252 Fastening member
260 Substrate
261 Fastening hole
262 Fastening member
270 Module fastening member
280a, 280b Heat sink fastening member
300 Lower case (housing)
310 Bottom surface
312 Protrusion
320, 330, 340, 360a, 360b Fastening portion
350 Opening
380 Side surface
400 Upper case
410 Plus output terminal
412 Plus output terminal bus bar
414 Fastening hole
420 Minus output terminal
422 Minus output terminal bus bar
424 Fastening hole
430 Connector
440 Gas discharge portion
442 Gas cover
444 Breather
450 Fastening portion

1. A battery pack comprising:
a plurality of battery cells stacked along a predetermined direction;
a cell case housing the battery cells;
a restraining plate attached to the cell case; and
a case housing the cell case;
wherein the cell case comprises an opening at each side in the predetermined direction;
wherein the restraining plate exerts pressure on the battery cells through the opening from one side in the predetermined direction;
wherein the case comprises a bottom surface; and
wherein the bottom surface of the case exerts pressure on the battery cells through the opening from an opposite side from the side where the restraining plate exerts pressure on the battery cells.

2. The battery pack of claim 1, further comprising a first insulating layer positioned between the restraining plate and the battery cells.

3. The battery pack of claim 1, further comprising a second insulating layer positioned between the bottom surface of the case and the battery cells.

4. The battery pack of claim 1, wherein a shape of a portion of the bottom surface of the case that exerts pressure on the battery cells includes at least one of a camber shape, an offset shape such that a portion of the bottom surface projects uniformly upward, and a ribbed shape.

5. The battery pack of claim 1, wherein a material forming the case is at least one of metal and resin.

6. The battery pack of claim 2, wherein the first insulating layer is an insulating member included on a surface layer of the battery cells.

7. The battery pack of claim 3, wherein the second insulating layer is an insulating member included on a surface layer of the battery cells.

8. The battery pack of claim 1, wherein a shape of a portion of the restraining plate that exerts pressure on the battery cells includes at least one of a camber shape, an offset shape such that a portion of the restraining plate projects uniformly upward, and a ribbed shape.

9. A battery module comprising:
a stacked plurality of battery cells;
a cell case surrounding the plurality of battery cells;
a housing supporting the cell case and the plurality of battery cells; and
a heat sink inserted between battery cells among the plurality of battery cells;
wherein the heat sink includes a fastening point projecting from the cell case and fastened to the housing; and
wherein the heat sink is fastened to the housing, and the heat sink and the housing sandwich the battery cells.

10. The battery module of claim 9,
wherein the cell case is formed from resin; and
wherein the housing is formed from metal.

11. The battery module of claim 9, wherein the housing comprises a fastening portion projecting from a bottom surface, and the fastening point abuts against the fastening portion.

12. The battery module of claim 9, further comprising a restraining plate covering a battery cell stacked on top among the plurality of battery cells and fastened to the cell case.

13. The battery module of claim 9, further comprising:
a plurality of the heat sinks;
wherein each heat sink is inserted between a different pair of adjacent battery cells among the plurality of battery cells;
wherein the cell case is fastened to the housing; and
wherein fastening points of the heat sinks to the housing and a fastening point of the cell case to the housing are disposed along a same side surface of the cell case.

14. The battery module of claim 13,
wherein fastening points of the cell case to the housing are provided at two locations along the same side surface of the cell case; and
wherein the fastening points of the plurality of heat sinks to the housing are disposed inward from the fastening points of the cell case provided at the two locations.

15. The battery module of claim 9, wherein the heat sink is electrically insulated from the battery cells.

16. The battery module of claim 15, wherein the heat sink is electrically insulated from the battery cells by at least one of an insulating layer forming a surface layer of the battery cells, an insulating sheet further disposed between the battery cells and the heat sink, and an insulating layer forming a surface layer of the heat sink.

17. The battery module of claim 9, wherein the heat sink is fixed to the housing via a heat dissipation agent.

18. A battery module comprising:
a stacked plurality of battery cells;
a cell case supporting the plurality of battery cells inside the cell case; and
a heat sink sandwiched between battery cells among the plurality of battery cells;
wherein the heat sink projects from the cell case and is fixed to a housing configured to house the cell case; and
wherein a fixing point of the cell case is positioned in a central region of the cell case in a stacking direction of the battery cells.
